(19) United States
(12) Patent Application Publication
(10) Pub. No.: US 2010/0321528 A1
(43) Pub. Date: Dec. 23, 2010

(54) APPARATUS AND METHODS FOR CONTROLLING IMAGE SENSORS

(76) Inventors: Xiaoguang YU, Wuhan (CN); Xiangshan GUAN, Wuhan (CN); Xinsheng PENG, Wuhan (CN); Libin SUI, Wuhan (CN); Zhihua LV, Wuhan (CN); Ruibei LIU, Wuhan (CN)

Correspondence Address: PATENT PROSECUTION;O2MIRCO , INC., 3118 PATRICK HENRY DRIVE, SANTA CLARA, CA, 95054, US

(21) Appl. No.: 12/837,723

(22) Filed: Jul. 16, 2010

Related U.S. Application Data
(63) Continuation-in-part of application No. 12/487,904, filed on Jun. 19, 2009.

(30) Foreign Application Priority Data
Feb. 5, 2010 (CN) 2010101081243

(51) Int. Cl. H04N 5/76; G06F 12/14

(52) U.S. Cl. 348/231.2; 348/E05.031; 713/189

(57) ABSTRACT

A computer system has machine-readable instructions stored thereon. The instructions when executed cause the computer system to perform a method of controlling a camera system. The method includes accessing a first data set in an image file. The first data set includes identification data indicating an identity of an image sensor associated with a previous boot of the camera system and configuration data indicating operation parameters of the image sensor associated with the previous boot. The method further includes: determining whether a matching is found between the identification data and an image sensor associated with a current boot of the camera system; and setting the image sensor associated with the current boot based on the configuration data of the first data set if the matching is found.

### RELATED APPLICATION

This application is a continuation-in-part of the co-pending U.S. application Ser. No. 12/487,904, titled “Apparatus and Methods for Controlling Image Sensors”, filed on Jun. 19, 2009, which is hereby incorporated by reference in its entirety. This application also claims priority to Patent Application No. 201010108124.3, titled “Methods, Devices, and Camera Systems for Controlling Image Sensors”, filed on Feb. 5, 2010, with the State Intellectual Property Office of the People's Republic of China.

### BACKGROUND

In recent years, electronic devices with image acquisition functions have become popular with consumers. Typically, a camera module employed in an electronic device, e.g., a personal computer or a cell phone, includes an image sensor that captures incident light to form an electronic representation of an image. That is, the image sensor is a semiconductor device that converts optical image signals into electrical image signals. The electronic device may not configure the image sensors properly as various types of image sensors need different settings. Moreover, the camera module usually includes an electrically erasable programmable read-only memory (E²PROM) to store configuration data of the image sensor. However, the cost of the camera module can be increased by the adoption of the E²PROM.

### SUMMARY

In one embodiment, a computer system has machine-readable instructions stored thereon. The instructions when executed cause the computer system to perform a method of controlling a camera system. The method includes accessing a first data set in an image file. The first data set includes identification data indicating an identity of an image sensor associated with a previous boot of the camera system and configuration data indicating operation parameters of the image sensor associated with the previous boot. The method further includes: determining whether a matching is found between the identification data and an image sensor associated with a current boot of the camera system; and setting the image sensor associated with the current boot based on the configuration data of the first data set if the matching is found.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a block diagram of a camera system, in accordance with one embodiment of the invention.

FIG. 2 illustrates a block diagram of a driver module, in accordance with one embodiment of the present invention.

FIG. 3 illustrates a flowchart of a method for controlling an image sensor, in accordance with one embodiment of the present invention.

FIG. 4 illustrates another block diagram of a driver module, in accordance with one embodiment of the present invention.

FIG. 5 illustrates another flowchart of a method for controlling an image sensor, in accordance with one embodiment of the present invention.

FIG. 6 illustrates another flowchart of a method for controlling an image sensor, in accordance with one embodiment of the present invention.

### DETAILED DESCRIPTION

Reference will now be made in detail to embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “determining,” “modifying,” “setting,” “encrypting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of machine-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

By way of example, and not limitation, computer-usable media may comprise computer storage media and communication media. Computer storage media includes volatile and nonvolatile, removable and non-removable media implemented in any method or technology for storage of information such as machine-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody machine-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer readable media.

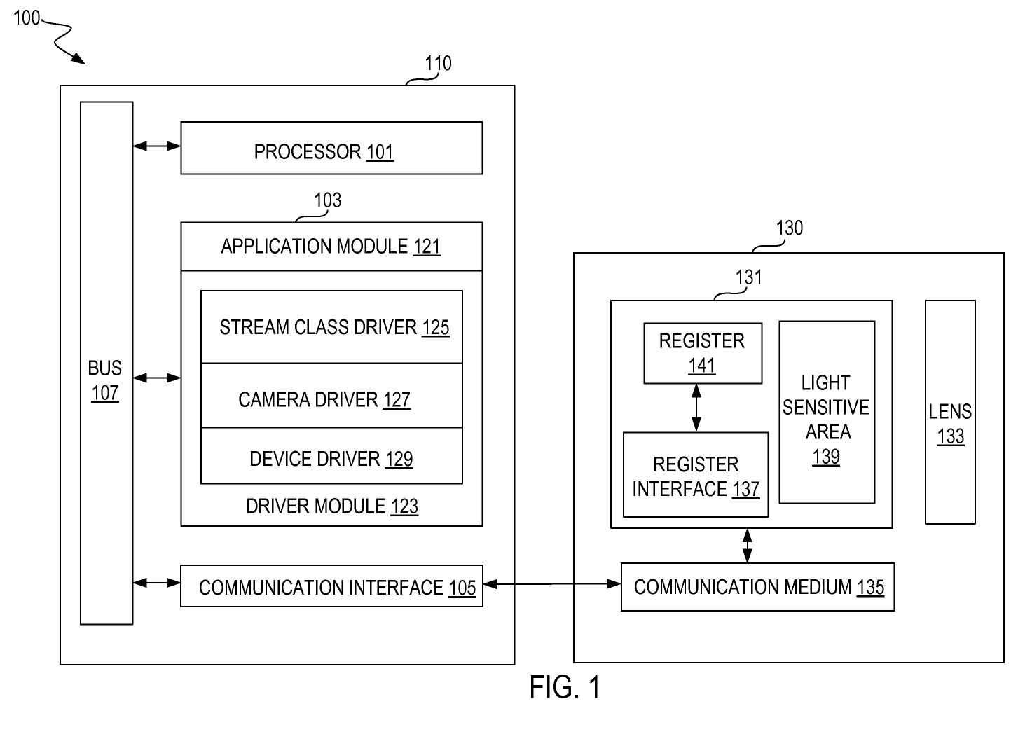

FIG. 1 illustrates a block diagram of a camera system 100 according to one embodiment of the invention. The camera system 100 includes a computer unit 110 and a camera module 130, in one embodiment. The computer unit 110 can control the camera module 130 to capture optical images and can receive electrical signals representing the captured images from the camera module 130. The computer unit 110 can be a cell phone, a personal computer, a workstation, or the like.

In one embodiment, the camera module 130 includes an image sensor 131, a lens 133, and a communication medium 135. The lens 133 can focus incoming light onto the image sensor 131. The image sensor 131 can capture optical image signals and can convert the optical image signals to analog electrical image signals. Furthermore, the image sensor 131 can convert the analog electrical image signals to digital raw image signals (e.g., digital images in a RAW format), in one embodiment. The image sensor 131 can be, but is not limited to, a charge-coupled device (CCD) image sensor or a complementary metal-oxide-semiconductor (CMOS) active-pixel sensor. In one embodiment, the image sensor 131 can include a register interface 137, a light sensitive area 139, and one or more registers 141. To distinguish image sensors of various types from each other, each type of the image sensors is allocated with a unique identification value. The identification value can be stored in one or more registers 141. Moreover, the registers 141 can store configuration data, thereby determining operation parameters of the image sensor 131, in one embodiment. The operation parameters determine different aspects of operation of the image sensor 131. For example, a corresponding operation parameter stored in the registers 141 can determine the nature of exposure, such as the amount of light impinging on the image sensor 131. A corresponding operation parameter stored in the registers 141 can determine the duration of the light exposure. The light sensitive area 139 senses the incident light to generate the analog electrical image signals.

The communication medium 135 can transfer control commands from the computer unit 110 to control an image acquisition function of the image sensor 131, e.g., to set or adjust operation parameters of the image sensor 131. The communication medium 135 can interface with the computer unit 110 according to a communication protocol such as a universal serial bus (USB) protocol or a 1394 protocol, etc. Furthermore, the communication medium 135 can interface with the image sensor 131 according to another communication protocol, such as an inter-integrated circuit (I²C) bus protocol or a serial camera control bus (SCCB) protocol. In other words, the image sensor 131 can support I²C/SCCB protocol, in one embodiment. As such, the communication medium 135 also provides a protocol conversion, e.g., between USB and I²C/SCCB. In addition, the communication medium 135 can transfer the digital image signals (e.g., digital raw image signals) from the image sensor 131 to the computer unit 110. The communication medium 135 can access the registers 141 via the register interface 137 according to the SCCB/I²C protocol.

In one embodiment, the computer unit 110 includes a processor 101 (e.g., a central processing unit), a memory (storage device) 103, a communication interface 105, and a bus 107. An operating system, e.g., WINDOWS XP, WINDOWS VISTA and LINUX, is installed into the computer unit 110. In one embodiment, the processor 101 processes instructions of various programs stored in the memory 103 to send commands to corresponding hardware elements. To run a particular program, the processor 101 loads the related instructions from the memory 103 and sends corresponding control commands to associated hardware elements to execute such instructions. The processor 101 can also send commands to control a device coupled to the computer unit 110, e.g., the camera 130, according to the instructions. Furthermore, the memory 103 is a machine-readable medium and can store machine-readable and/or machine-executable data, which can be processed by the processor 101. The communication interface 105 can include a serial interface, a parallel interface, and/or other types of interfaces, and is capable of sending and receiving electrical, electromagnetic or optical signals that carry digital data streams. For example, the communication interface 105 interfaces with the communication medium 135 to transfer the electrical image signals and control commands regarding image acquisition management. Communications among hardware elements of the computer unit 110, e.g., the processor 101, the memory 103, and the communication interface 105, are established via the bus 107.

The memory 103 can store an application module 121 and a driver module 123, in one embodiment. The application module 121 can include user-mode programs which run in foreground and interact with users. The driver module 123 can include kernel-mode programs which run in background and are invisible to the users. In one embodiment, the driver module 123 includes a stream class driver 125, a camera driver 127, and a device driver 129. The application module 121 and the driver module 123 can be executed by the processor 101.

In one embodiment, the stream class driver 125 can be provided by the operating system and serve as a bridge linking the upper level user-mode programs and the lower level kernel-mode programs. For example, if a user starts a video call function of a user-mode program, the user-mode program can issue an image request. The stream class driver 125 will receive the image request and invoke the camera driver 127 to start the camera module 130 in response to the image request. The camera driver 127 is developed for driving image sensors of various types. Even if the camera module 130 replaces the image sensor 131 with a different type of image sensor, the camera driver 127, without updating, can still identify and configure the newly employed image sensor, in one embodiment. In other words, the camera driver 127 is a universal driver for various image sensors. Furthermore, the camera driver 127 invokes the device driver 129 to establish communications between the communication interface 105 and the communication medium 135, thereby enabling communications between the computer unit 110 and the image sensor 131. For example, the device driver 129 can be executed by the processor 101 to detect/recognize signals, e.g., digital raw image signals, from the image sensor 131, and to translate such signals from the image sensor 131 to corresponding machine-readable data. In addition, the device driver 129 can translate the machine-readable data, e.g., computer commands from the computer unit 110, into sensor-readable signals. In one embodiment, the device driver 129, e.g., a USB driver, can be provided by the operating system.

Advantageously, the camera driver 127 can support various image sensors, therefore making the camera system 100 more flexible and user-friendly. Furthermore, E²PROM is eliminated from the camera module 130. Therefore, the cost of the camera system 100 can be reduced.

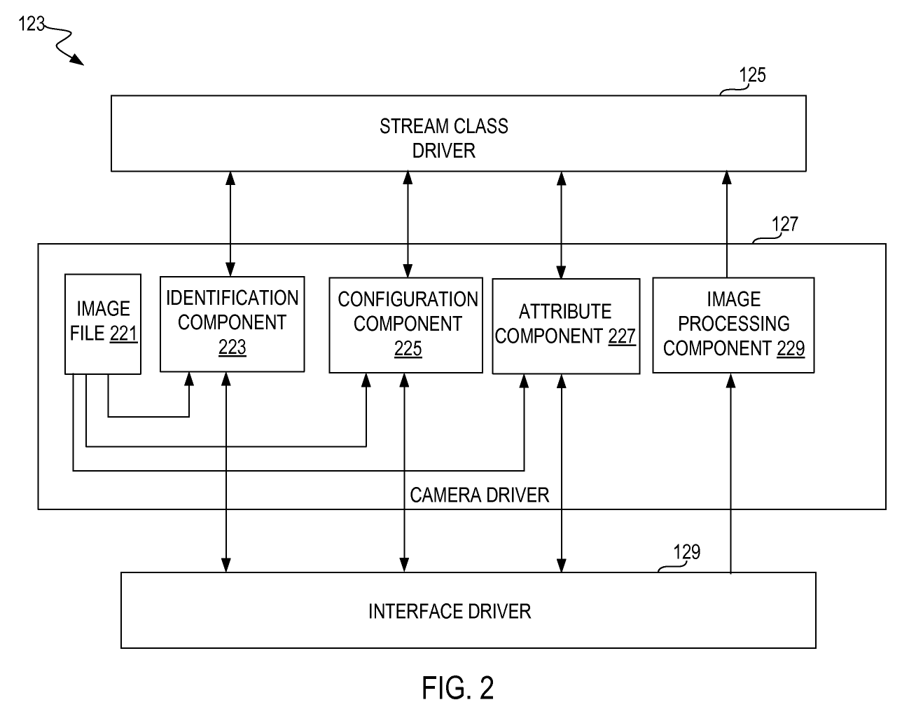

FIG. 2 illustrates a block diagram of the driver module 123 according to one embodiment of the present invention. Elements labeled the same as in FIG. 1 have similar functions. FIG. 2 is described in combination with FIG. 1. In one embodiment, the camera driver module 127 includes an image file 221, an identification component 223, a configuration component 225, an attribute component 227, and an image processing component 229.

The image file 221 stores machine-readable data sets associated with different image sensors. In one embodiment, each of the data sets defines identification data and configuration data associated with a corresponding image sensor. The identification data indicates a sensor type (or an identity) of the corresponding image sensor. For example, the identification data of the image sensor 131 can include the identification value as mentioned in relation to FIG. 1, one or more address values, and an address count value. The address values indicate the addresses of the registers 141. The address count value indicates the number of the registers 141 for storing the identification value. By way of example, if the identification value is 16-bits long, the identification value can be stored in two 8-bit registers. Thus, the address values include the addresses of the two 8-bit registers and the address count value is 2. In the following description, the identification value stored in the image file 221 is named as the local identification value, and the identification value stored in the registers 141 is named as the remote identification value. In one embodiment, the identification data of the image sensor 131 can also include a protocol value indicating the communication protocol (e.g., the I²C protocol and the SCCB protocol) supported by the image sensor 131. The corresponding configuration data indicate operation parameters of the image sensor 131.

Advantageously, the image file 221 can be updated to include additional data sets associated with the image sensors unknown to the computer unit 110. For example, data sets associated with new image sensors can be written into the image file 221 to make such image sensors recognizable by the camera driver application 127. As such, the camera driver application 127 can be customized to support various arbitrary image sensors.

The identification component 223 executed by the processor 101 can compare the remote identification value in the image sensor 131 (e.g., the remote identification value stored in the registers 141) to the local identification values contained in the data sets in the image file 221. The image sensor 131 can be identified if the local identification value contained in one of the data sets matches to the remote identification value. More specifically, the identification component 223 includes machine-executable instruction codes for acquiring the remote identification value of the image sensor 131 (by way of example) according to the address values and the address count value contained in a corresponding data set, and for identifying the image sensor 131 automatically by comparing the remote identification value to the local identification values contained in the corresponding data set. The configuration component 225 includes machine-executable instruction codes for reading the configuration data contained in the corresponding data set, and for setting the operation parameters of the image sensor 131 according to the corresponding configuration data.

The image processing component 229 includes machine-executable instruction codes for performing a digital graphic processing on the digital image signals from the camera module 130. More specifically, the image processing component 229 can adjust the image attributes, e.g., brightness, color, saturation, and noise-signal ratio of the digital image signals by various digital processing algorithms such as geometric transformation, color processing, image composite, image denoising, and image enhancement. As a result, the digital raw image signals can be converted into color-corrected images with a standard image file format, e.g., a joint photographic experts group (JPEG) standard.

In one embodiment, the data sets stored in the image file 221 can further define attribute data indicating the image attributes, e.g., the brightness, color, saturation, and noise-signal ratio of the digital image signals. The attribute component 227 includes machine-executable instruction codes for adjusting image attributes of the digital image signals. If the user-mode programs issue requests for adjusting the image attributes, the attribute component 227 can read the attribute data from the image file 221 and adjust the image attributes accordingly.

In one embodiment, the camera driver module 127 further includes a determining component and an updating component. The determining component includes machine-executable instruction codes for determining the communication protocol supported by the image sensor 131 and whether a successful communication with the image sensor 131 has been established. The updating component includes machine-executable instruction codes for updating the image file 221 if none of the data sets includes the identification data matching to the image sensor 131.

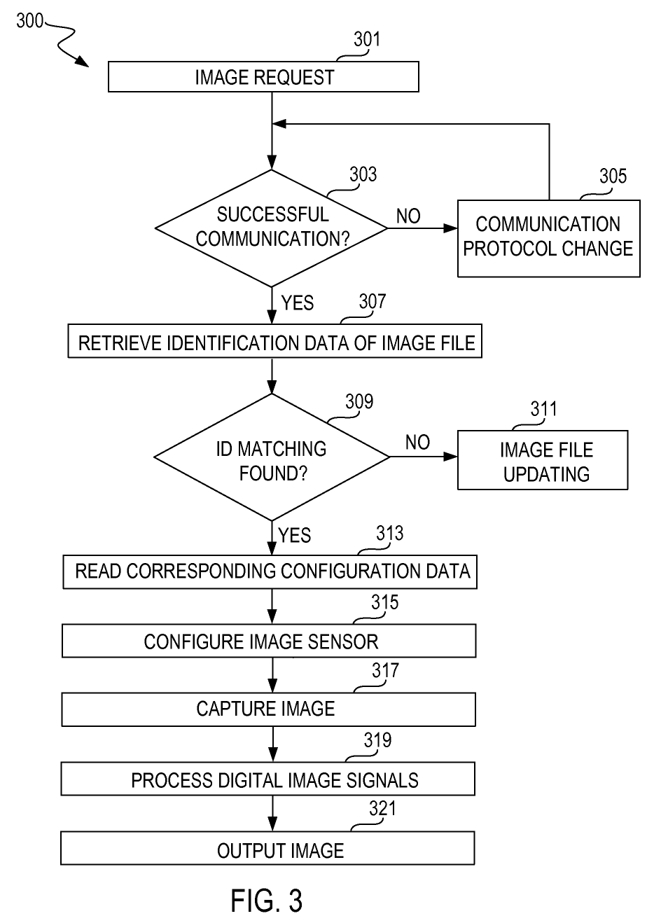

FIG. 3 illustrates a flowchart 300 of a method for controlling an image sensor according to one embodiment of the present invention. Although specific steps are disclosed in FIG. 3, such steps are examples. That is, the present invention is well suited to performing various other steps or variations of the steps recited in FIG. 3. FIG. 3 is described in combination with FIG. 1 and FIG. 2. In one embodiment, the flowchart 300 is implemented as machine-executable instructions stored in a machine-readable medium.

At step 301, an image request is issued by a user-mode program, e.g., a video application program. In response to the image request, the stream class driver 125 invokes the camera driver 127 which is therefore loaded from the memory 103 and processed by the processor 101, along with the image file 221. The tasks programmed in the camera driver 127 can be executed accordingly. The tasks will be described in detail in the following descriptions regarding step 303 through step 321.

At step 303, the determining component of the camera driver 127 determines whether a successful communication with the image sensor 131 has been established. For example, assuming that the communication protocol supported by the image sensor 131 is I²C and the communication interface 105 uses the USB protocol to interface with the communication medium 135, the successful communication can not be set up if the communication medium 135 conducts a USB to SCCB protocol conversion. In this instance, the SCCB protocol is changed to the I²C protocol, and the communication medium 135 executes the USB to I²C protocol conversion at step 305. Following the communication protocol change at step 305, step 303 is executed again to determine that the successful communication has been established. By now, the communication protocol supported by the image sensor 131 is determined.

Alternatively, the protocol value of the identification data can be used as a default communication protocol in communication establishment at step 303. That is, the protocol value is assumed as the communication protocol by the determining component of the camera driver 127 in the first trial of communication establishment. By using the protocol value as the default communication protocol, the possibility of successful communication establishment in the first trial is increased. As such, system efficiency is enhanced.

At step 307, the identification data stored in the image file 221 are accessed. For the identification data of each data set, an identifying component of the camera driver 127 determines whether an ID matching is found at step 309. More specifically, an acquiring component of the camera driver 127 reads the remote identification value of the image sensor 131 from the registers 141 according to the address values and the address count value of the identification data. The identifying component compares the remote identification value of the image sensor 131 with the local identification value of the identification data to make the determination. The acquiring component and the identifying component constitute the identification component 223, in one embodiment. If the remote and local identification values are identical, the ID matching is found. In this instance, the corresponding configuration data is read at step 313 and the image sensor 131 is configured at step 315. If the ID matching is not found after comparing the identification values in all the data sets in the image file 221 to the remote identification value, the image file 221 can be updated at step 311 to include an additional data set associated with the unknown image sensor 131.

At step 317, the image sensor 131 captures the optical images and generates digital image signals according to the configured operation parameters. At step 319, the digital image signals are processed to generate color-corrected images. At step 321, the color-corrected images are transmitted to the user-mode program via the stream class driver 125 for display.

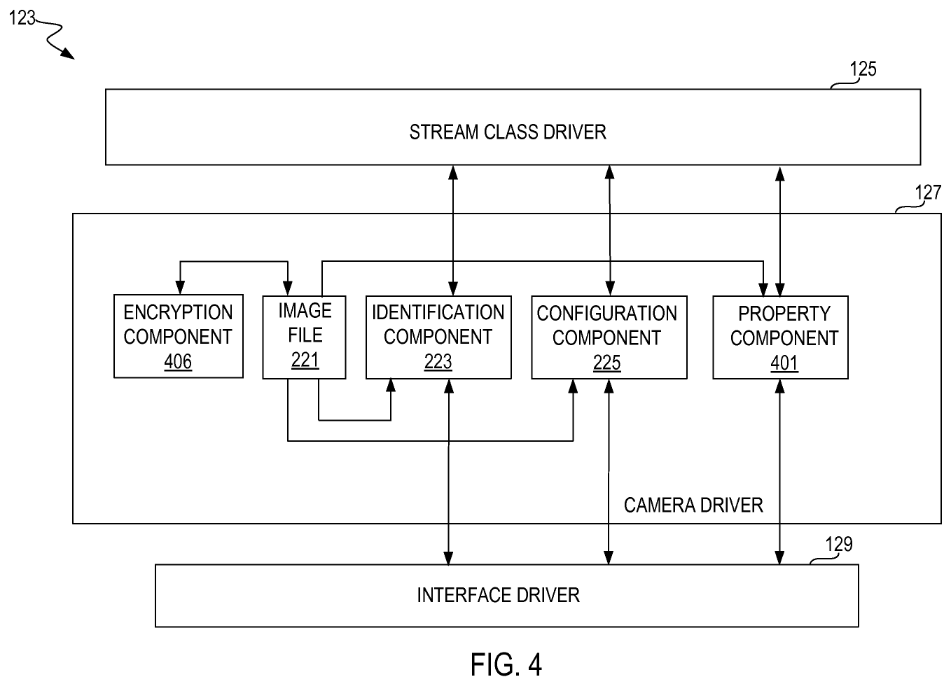

FIG. 4 illustrates another block diagram of the driver module 123, in accordance with one embodiment of the present invention. Elements labeled the same as in FIG. 2 have similar functions. FIG. 4 is described in combination with FIG. 1 and FIG. 2. In the example of FIG. 4, the camera driver module 127 includes the image file 221, the identification component 223, the configuration component 225, a property component 401, and an encryption component 406.

As discussed in relation to FIG. 2, the image file 221 can store machine-readable data sets associated with different image sensors respectively. Each of the data sets can include identification data, configuration data, and property data associated with a corresponding image sensor, in one embodiment. The identification data indicates an identity of the corresponding image sensor. The identification component 223 includes machine-executable instruction codes for accessing the data sets in the image file 221 to identify the image sensor 131. More specifically, the identification component 223 can be executed by the processor 101 to compare the remote identification value in the image sensor 131 (e.g., the remote identification value stored in the registers 141) to the identification data (e.g., the local identification value) contained in the data sets in the image file 221. The image sensor 131 can be identified if the local identification value contained in one of the data sets matches to the remote identification value.

In one embodiment, if the identification component 223 identifies the image sensor 131 and determines that the identification data in the data set DSET1 matches to the image sensor 131, the image file 221 can further store or update an index to indicate an address of the data set DSET1 matching to the image sensor 131. The camera system 100 may be then powered off or the image sensor 131 may be removed, e.g., by the user. When the camera system 100 is powered on or an image sensor is connected to the computer unit 110 again, the identification component 223 can access the data sets according to the index stored in the image file 221. More specifically, the identification component 223 can first access the data set DSET1, that is, the data set matching to the image sensor coupled to the computer unit 110 in a previous boot, e.g., in the last boot.

The processor 101, by executing the identification component 223, can compare the remote identification value in the image sensor 131 (e.g., the remote identification value stored in the registers 141) to the identification data contained in the data set DSET1. If the identification component 223 determines that the identification data in the data set DSET1 matches to the image sensor 131 (e.g., the type of the image sensor 131 in the current boot is the same as the type of the image sensor 131 in the last boot), the configuration component 225 can configure the image sensor 131 according to configuration data in the data set DSET1. In this circumstance, the identification component 223 may not need to access other data sets, which can further improve the efficiency of the camera system 100.

If no matching between the identification data in the data set DSET1 and the image sensor 131 is found (e.g., the type of the image sensor 131 in the current boot is different from the type of the image sensor 131 in the last boot), the identification component 223 can access the other data sets until a data set DSET2 associated with the image sensor 131, e.g., the identification data in the data set DSET2 matches to the image sensor 131, is found. Furthermore, the identification component 223 can update the index in the image file 221 to indicate an address of the corresponding data set DSET2. Therefore, when the camera system 100 is rebooted in a subsequent boot, the identification component 223 can first access the data set DSET2 according to the updated index.

The configuration data in a corresponding data set indicates operation parameters of the image sensor 131. In one embodiment, the configuration data in a corresponding data set indicates default or initial operation parameters of the image sensor 131. In one embodiment, the configuration component 225 includes machine-executable instruction codes for reading the configuration data from a corresponding data set, e.g., DSET1 or DSET2, and for setting the operation parameters of the image sensor 131 according to the configuration data, e.g., by writing values of the operation parameters into the corresponding registers 141 according to the configuration data.

The operation parameters configured by the configuration component 225 can determine different aspects of the operation of the image sensor 131. For example, a corresponding operation parameter stored in the registers 141 can determine the nature of exposure, such as the amount of light impinging on the image sensor 131. A corresponding operation parameter stored in the registers 141 can determine the duration of the light exposure. As such, the image sensor 131 can operate to generate digital image signals according to the configuration data representing the operation parameters of the image sensor 131.

Different computer units, e.g., from different manufacturers, may prefer different settings of the image sensor 131. In one embodiment, the configuration data can include multiple classes corresponding to multiple types of the computer unit 110 respectively. In one embodiment, the identification component 223 further includes machine-executable instruction codes for identifying the computer unit 110, e.g., by reading a basic input output system (BIOS) of the computer unit 110. As such, the configuration component 225 can select a class corresponding to the identified type of the computer unit 110, and can configure the image sensor 131 accordingly. More specifically, the configuration component 225 can write the corresponding value of the selected class into the corresponding registers 141. By configuring the image sensor 131 according to the type of the computer unit 110, the camera system 100 can further improve its performance.

The properties of the image sensor 131 can indicate perceptible attributes associated with the image sensor 131. The properties of the image sensor 131 can include, but are not limited to, image attributes (e.g., brightness, contrast, color, hue, and saturation) and/or sensor attributes (e.g., output image format and anti-flicker performance).

In one embodiment, the properties can be determined by the operation parameters stored in the registers 141. By way of example, some of the registers 141 store operation parameters that can determine the “brightness” image attribute. More specifically, the operation parameters of the image sensor 131 relating to the brightness weight value, gamma curve, exposure time, exposure method, aperture value, shutter speed, etc., can determine the brightness of the digital images generated by the image sensor 131.

During operation, one or more properties of the image sensor 131 may be adjusted, e.g., by a user-mode program which runs in foreground and interacts with users. In one embodiment, if a property tab of the user-mode program is reconfigured, e.g., by users, the user-mode program can modify the corresponding operation parameters associated with the property tab so as to modify a corresponding property. By way of example, in order to adjust the brightness of the digital images generated by the image sensor 131, the user-mode program can modify the corresponding operation parameters relating to the brightness weight value, the gamma curve, the exposure time, the exposure method, the aperture value, the shutter speed, etc. of the image sensor 131.

In one embodiment, the property component 401 includes machine-executable instruction codes to provide or update the property data according to reconfigured or modified operation parameters indicating the properties of the image sensor 131 adjusted by the user-mode program. For example, the property data can include reconfigured or modified values of the corresponding operation parameters. Alternatively, the property data can include addresses of the memory 103 which stores the reconfigured or modified values of the corresponding operation parameters.

The camera system 100 may be then powered off or the image sensor 131 may be removed, e.g., by the user. When the camera system 100 is powered on or an image sensor is connected to the computer unit 110 again, the property component 401 can be executed after the identification and the configuration (e.g., configuring the image sensor with default or initial operating parameters and/or according to the identified type of the computer unit 110) are completed. In one embodiment, the property component 401 further includes machine-executable instruction codes for accessing the property data indicating properties adjusted during a previous boot of the image sensor having the same type, that is, a previous boot of the camera system 100 when the image sensor having the same type coupled to the computer unit 110, and for setting the properties of the image sensor in the current boot based on the property data. As such, the properties can be automatically adjusted according to the previous settings by the user, which is more user-friendly.

The encryption component 406 includes machine-executable instruction codes for encrypting and decrypting the data sets in the image file 221. For example, the encryption component 406 can encrypt a data set if the data set is stored into the image file 221 and can decrypt the data set if the data set is read from the image file 221. Consequently, the security performance of the camera system 100 can be enhanced. In one embodiment, the encryption component 406 can be executed by the processor 101 to perform hash operations and symmetric encryption/decryption algorithms to encrypt and decrypt the data set.

Advantageously, the encryption component 406 can encrypt the configuration data and the property data, and can maintain the identification data unencrypted when the data set is stored into the image file 221, in one embodiment. Thus, the identification data can be used to identify the image sensor 131 before decrypting the data sets in the image file 221. More specifically, if the corresponding identification data of a data set, e.g., DSET3, matches to the remote identification value of the image sensor 131, the configuration data and the property data of the data set DSET3 can be decrypted for configuration and property setting. If no matching between the identification data in the data set DSET3 and the image sensor 131 is found, the camera driver 127 retrieves other data sets without decrypting the configuration data and the property data in the data set DSET3, which further improves the system efficiency.

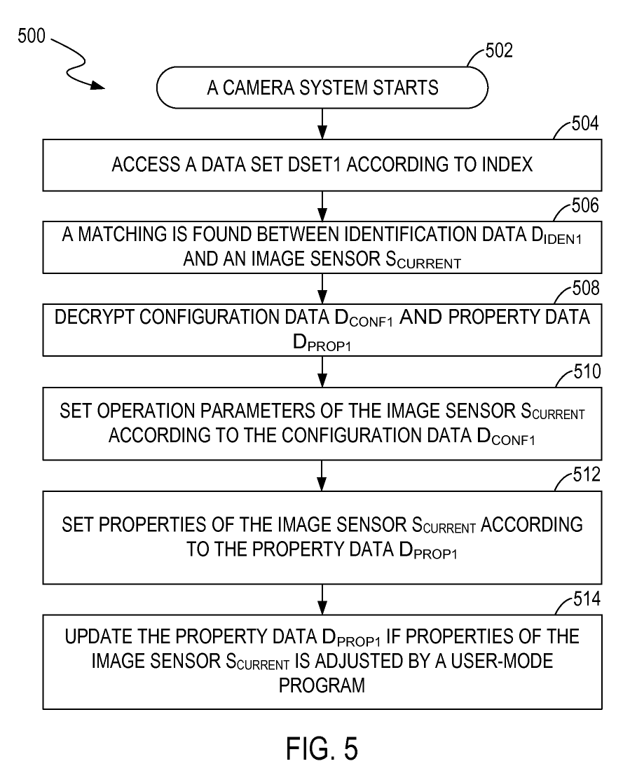

FIG. 5 illustrates a flowchart 500 of a method for controlling an image sensor, e.g., the image sensor 131, according to one embodiment of the present invention. Although specific steps are disclosed in FIG. 5, such steps are examples. That is, the present invention is well suited to performing various other steps or variations of the steps recited in FIG. 5. FIG. 5 is described in combination with FIG. 1, FIG. 2, and FIG. 4. In one embodiment, the flowchart 500 is implemented as machine-executable instructions stored in a machine-readable medium.

In a previous boot of the camera system 100, a data set DSET1 including identification data D_{IDEN1}, configuration data D_{CONF1}, and property data D_{PROP1} is used to identify and configure an image sensor S_{PREVIOUS}. For example, the identification data D_{IDEN1} has a local identification value matches to a remote identification value of the image sensor S_{PREVIOUS}. The configuration data D_{CONF1} indicates operation parameters of the image sensor S_{PREVIOUS}. The property data D_{PROP1} indicates properties of the image sensor S_{PREVIOUS} associated with the previous boot. As such, the image file 221 can further store an index indicating an address of the data set DSET1. In one embodiment, the configuration data D_{CONF1} and the property data D_{PROP1} are encrypted. The identification data D_{IDEN1} is unencrypted. In the example of FIG. 5, the image sensor S_{CURRENT} coupled to the computer unit 110 in the current boot has the same sensor type as the image sensor S_{PREVIOUS} in the previous boot.

At step 502, a camera system, e.g., the camera system 100, is started. In one embodiment, the processor 101 loads the image file 221 stored in the memory 103 and executes the machine-executable camera driver 127 stored in the memory 103.

At step 504, the data set DSET1 is accessed according to the index in the image file 221. At step 506, the identification component 223 compares the identification data D_{IDEN1} to the remote identification value of the image sensor S_{CURRENT} coupled to the computer unit 110 in the current boot. Since the image sensor S_{CURRENT} has the same sensor type as the image sensor S_{PREVIOUS}, an ID matching is found. Thus, the image sensor S_{CURRENT} is identified. Advantageously, the identification component 223 may not need to retrieve other data sets in the image file 221, and thus the efficiency of the camera system 100 can be further improved.

At step 508, the encryption component 406 decrypts the configuration data D_{CONF1} and the property data D_{PROP1} of the data set DSET1. At step 510, the configuration component 225 sets the operation parameters of the image sensor S_{CURRENT} according to the configuration data D_{CONF1}. In one embodiment, the identification component 223 further identifies the computer unit 110. Therefore, the configuration component 225 can select a class of the configuration data D_{CONF1} corresponding to the identified type of the computer unit 110 and can configure the image sensor S_{CURRENT} accordingly.

At step 512, the property component 401 sets properties of the image sensor S_{CURRENT} according to the property data D_{PROP1}. Thus, the properties of the image sensor S_{CURRENT} can be adjusted to be consistent with those of the image sensor S_{PREVIOUS}, which can be more user-friendly. For example, if the property data D_{PROP1} indicates that the brightness is adjusted to level 2 by the user-mode program, e.g., according to a user demand, in the previous boot, the brightness can be automatically adjusted to level 2 in the current boot. At step 514, if the properties of the image sensor S_{CURRENT} are further adjusted by the user-mode program, e.g., according to a user demand, in the current boot, the property component 401 can update the property data D_{PROP1} to indicate the properties adjusted by the user-mode program. For example, if the saturation is adjusted to level 1 by the user-mode program, e.g., according to a user demand, in the current boot, the property component 401 can update the property data D_{PROP1} to indicate the brightness level 2 and the saturation level 1.

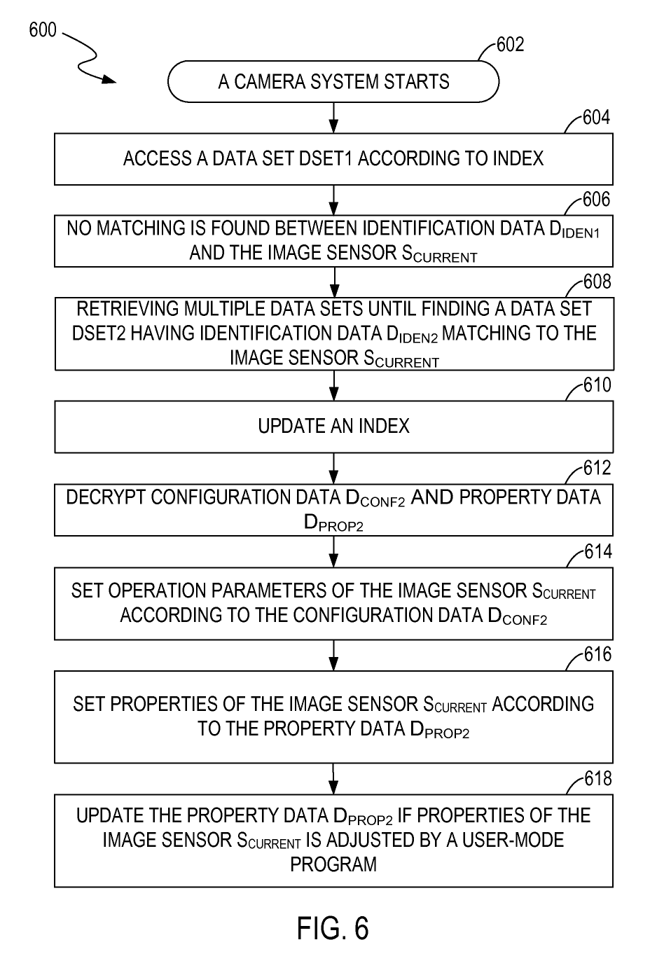

FIG. 6 illustrates a flowchart 600 of a method for controlling an image sensor, e.g., the image sensor 131, according to one embodiment of the present invention. Although specific steps are disclosed in FIG. 6, such steps are examples. That is, the present invention is well suited to performing various other steps or variations of the steps recited in FIG. 6. FIG. 6 is described in combination with FIG. 1, FIG. 2, FIG. 4, and FIG. 5. In one embodiment, the flowchart 600 is implemented as machine-executable instructions stored in a machine-readable medium.

In a previous boot of the camera system 100, a data set DSET1 including identification data D_{IDEN1}, configuration data D_{CONF1}, and property data D_{PROP1} is used to identify and configure an image sensor S_{PREVIOUS}. As such, the image file 221 can further store an index indicating an address of the data set DSET1. In the example of FIG. 6, the image sensor S_{CURRENT} coupled to the computer unit 110 in the current boot has a different sensor type compared to the image sensor S_{PREVIOUS} in the previous boot.

At step 602, a camera system, e.g., the camera system 100, is started. At step 604, the data set DSET1 is accessed according to the index in the image file 221. At step 606, the identification component 223 compares the identification data D_{IDEN1} to the remote identification value of the image sensor S_{CURRENT} coupled to the computer unit 110 in the current boot. Since the image sensor S_{CURRENT} and the image sensor S_{PREVIOUS} have different sensor types, no ID matching is found.

At step 608, other data sets in the image file 221 are retrieved until a data set DSET2 having identification data D_{IDEN2} matching to the remote identification value of the image sensor S_{CURRENT} is found. The data set DSET2 further includes configuration data D_{CONF2} and property data D_{PROP2}. Thus, the configuration data D_{CONF2} indicates operation parameters of the image sensor S_{CURRENT}. The property data D_{PROP2} indicates properties of the image sensor S_{CURRENT} or an image sensor of the same type coupled to the computer unit 110 in a previous boot of the camera system 100. In one embodiment, the configuration data D_{CONF2} and the property data D_{PROP2} are encrypted. The identification data D_{IDEN2} is unencrypted.

At step 610, the index in the image file 221 is updated to indicate an address of the data set DSET2. At step 612, the encryption component 406 decrypts the configuration data D_{CONF2} and the property data D_{PROP2} of the data set DSET2. At step 614, the configuration component 225 sets the operation parameters of the image sensor S_{CURRENT} according to the configuration data D_{CONF2}.

At step 616, the property component 401 sets the properties of the image sensor S_{CURRENT} according to the property data D_{PROP2}. At step 618, if the properties of the image sensor S_{CURRENT} are adjusted by the user-mode program, e.g., according to a user demand, the property component 401 updates the property data D_{PROP2} to indicate the properties adjusted by the user-mode program.

In summary, embodiments in accordance with the present disclosure provide a camera system that can identify an image sensor according to the identification information in a previous boot. Moreover, the image sensor 131 can be configured according to the type of a computer unit coupled to the image sensor, which can further improve the performance the camera system 100. Furthermore, the camera system can configure the image sensor according to the settings applied in a previous boot. As such, image acquisition and representation associated with the previous boot is readily applicable to the current boot of the camera system 100 and the user is freed from relatively tedious reconfiguration of the image sensor 131 in each boot of the camera system 100, which is more user-friendly.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A computer system having machine-readable instructions stored thereon, wherein said instructions when executed cause said computer system to perform a method of controlling a camera system, said method comprising:
accessing a first data set in an image file, wherein said first data set comprises identification data indicating an identity of an image sensor associated with a previous boot of said camera system and configuration data indicating operation parameters of said image sensor associated with said previous boot;
determining whether a matching is found between said identification data and an image sensor associated with a current boot of said camera system; and
setting said image sensor associated with said current boot based on said configuration data of said first data set if said matching is found.

2. The computer system as claimed in claim 1, wherein said method further comprises:
accessing a second data set in said image file if no matching is found between said identification data in said first data set and said image sensor associated with said current boot; and
setting said image sensor associated with said current boot based on configuration data of said second data set if identification data in said second data set matches to said image sensor associated with said current boot.

3. The computer system as claimed in claim 2, wherein said method further comprises:
accessing an index indicating an address of said first data set; and
updating said index to indicate an address of said second data set.

4. The computer system as claimed in claim 1, wherein said first data set further comprises property data indicating properties of said image sensor associated with said previous boot, and wherein said method further comprises:
setting properties of said image sensor associated with said current boot based on said property data if said matching is found.

5. The computer system as claimed in claim 1, wherein said first data set further comprises property data indicating properties of said image sensor associated with said previous boot, and wherein said method further comprises:
adjusting properties of said image sensor associated with said current boot; and
updating said property data to indicate said adjusted properties.

6. The computer system as claimed in claim 1, wherein said method further comprises:
encrypting data stored into said image file; and
decrypting data read from said image file.

7. The computer system as claimed in claim 1, wherein said method further comprises:
encrypting said configuration data of said first data set; and
decrypting said configuration data of said first data set if said matching is found.

8. The computer system as claimed in claim 1, wherein said method further comprises:
accessing an index indicating an address of said first data set; and
accessing said first data set according to said index.

9. The computer system as claimed in claim 1, wherein said configuration data of said first data set comprises a plurality of classes corresponding to a plurality of computer unit types respectively.

10. The computer system as claimed in claim 9, wherein said method further comprises:
identifying a type of a computer unit coupled to said image sensor associated with said current boot; and
selecting a class corresponding to said type of said computer unit from said classes.

11. A machine-readable medium having machine-executable components stored thereon for controlling a camera system, said machine-executable components comprising:
an image file for storing a first data set, wherein said first data set comprises identification data indicating an identity of an image sensor associated with a previous boot of said camera system and configuration data indicating operation parameters of said image sensor associated with said previous boot;
an identification component for accessing said first data set and for determining whether a matching is found between said identification data and an image sensor associated with a current boot of said camera system; and
a configuration component for setting said image sensor associated with said current boot based on said configuration data of said first data set if said matching is found.

12. The machine-readable medium as claimed in claim 11, wherein said identification component accesses a second data set in said image file if no matching is found between said identification data in said first data set and said image sensor associated with said current boot, and wherein said configuration component sets said image sensor associated with said current boot based on configuration data of said second data set if identification data in said second data set matches to said image sensor associated with said current boot.

13. The machine-readable medium as claimed in claim 12, wherein said image file further stores an index indicating an address of said first data set, and wherein said identification component updates said index to indicate an address of said second data set.

14. The machine-readable medium as claimed in claim 11, wherein said first data set further comprises property data indicating properties of said image sensor associated with said previous boot, and wherein said machine-executable components further comprise a property component for setting properties of said image sensor associated with said current boot based on said property data if said matching is found.

15. The machine-readable medium as claimed in claim 11, wherein said first data set further comprises property data indicating properties of said image sensor associated with said previous boot, and wherein said machine-executable components further comprise a user-mode program for adjusting properties of said image sensor associated with said current boot and a property component for updating said property data to indicate said properties adjusted by said user-mode program.

16. The machine-readable medium as claimed in claim 11, wherein said machine-executable components further comprise an encryption component for encrypting data stored into said image file and decrypting data read from said image file.

17. The machine-readable medium as claimed in claim 11, wherein said machine-executable components further comprise an encryption component for encrypting said configuration data of said first data set and maintaining said identification data of said first data set unencrypted if said first data set is stored into said image file.

18. The machine-readable medium as claimed in claim 11, wherein said image file stores an index indicating an address of said first data set, and wherein said identification component accesses said first data set according to said index.

19. The machine-readable medium as claimed in claim 11, wherein said configuration data comprises a plurality of classes corresponding to a plurality of computer unit types respectively.

20. The machine-readable medium as claimed in claim 19, wherein said identification component is further capable of identifying a type of a computer unit coupled to said image sensor associated with said current boot, and selecting a class corresponding to said type of said computer unit from said classes.

21. A camera system for controlling an image sensor, said camera system comprising:
a processor operable for executing a plurality of machine-executable components and for generating control commands;
memory coupled to said processor and operable for storing said machine-executable components and storing an image file comprising a plurality of data sets associated with a plurality of image sensors respectively, at least one of said data sets comprising identification data indicating an identity of one of said image sensors, and comprising property data indicating properties of said one of said image sensors adjusted during a previous boot of said one of said image sensors, wherein said machine-executable components comprise a camera driver for selecting a first data set of said data sets comprising identification data matching to said image sensor and for generating said control commands to set said image sensor according to property data of said first data set; and
a communication interface coupled to said processor and operable for transferring said control commands to said image sensor.

22. The camera system as claimed in claim 21, wherein said image file further comprises an index indicating an address of said first data set if said first data set is selected in a previous boot of said camera system, and wherein said camera driver is capable of accessing said first data set according to said index.

23. The camera system as claimed in claim 21, wherein said image file further comprises an index indicating an address of a second data set selected in a previous boot of said camera system, and wherein said camera driver is capable of retrieving said data sets until finding said first data set and updating said index to indicate an address of said first data set.

24. The camera system as claimed in claim 21, wherein said machine-executable components further comprise a user-mode program for adjusting properties of said image sensor, and wherein said camera driver is capable of updating said property data of said first data set to indicate said properties adjusted by said user-mode program.

25. The camera system as claimed in claim 21, wherein said first data set further comprises configuration data indicating operation parameters of said image sensor, and wherein said configuration data comprises a plurality of classes corresponding to a plurality of computer unit types, and wherein said camera driver selects a class corresponding to a type of a computer unit coupled to said image sensor from said classes and sets said image sensor according to said selected class of said configuration data.

26. The camera system as claimed in claim 21, wherein said camera driver encrypts said data sets if said data sets are stored to said image file, and wherein said camera driver decrypts said data sets if said data sets are read from said image file.

27. The camera system as claimed in claim 21, wherein said camera driver is capable of encrypting said property data of said data sets and maintaining said identification data of said data sets unencrypted.
